(19) United States
(12) Patent Application Publication
(10) Pub. No.: US 2025/0138547 A1
(43) Pub. Date: May 1, 2025

(54) RANGE ESTIMATION FOR VEHICLE WITH TRAILER

(71) Applicant: FCA US LLC, Auburn Hills, MI (US)

(72) Inventors: Djura Vudrag, Tecumseh (CA); Douglas W. Killian, Fenton, MI (US)

(21) Appl. No.: 18/496,959

(22) Filed: Oct. 30, 2023

(51) Int. Cl. G07C 5/02; B60G 17/016; B60Q 9/00; G06T 7/60; G06T 7/70; G06V 20/56

(52) U.S. Cl. CPC G05D 1/60

(57) ABSTRACT

In at least some implementations, a method for determining range for a vehicle connected to a trailer includes determining connection of a trailer to the vehicle, determining at least one trailer parameter relating to a size, shape or a weight of the trailer, and determining a reduction in vehicle range as a function of the at least one trailer parameter.

### FIELD

The present disclosure relates to estimating a vehicle range when the vehicle is pulling a trailer.

### BACKGROUND

A vehicle must use additional energy to tow a trailer. The additional energy consumption reduces the total range a vehicle can be driven on a given supply of energy, whether that energy is in the form of fuel or stored electrical energy. More accurate determinations of the range of a vehicle are needed when the vehicle is towing a trailer, to ensure that the vehicle can be driven to a refueling station or a recharging station along a desired path of travel.

### SUMMARY

In at least some implementations, a method for determining range for a vehicle connected to a trailer includes determining connection of a trailer to the vehicle, determining at least one trailer parameter relating to a size, shape or a weight of the trailer, and determining a reduction in vehicle range as a function of the at least one trailer parameter.

In at least some implementations, the at least one trailer parameter includes an estimated weight of the trailer, and the estimated weight of the trailer is determined by a load sensor of the vehicle. In at least some implementations, the load sensor is a ride height sensor of a vehicle suspension system, or a pressure sensor or the like.

In at least some implementations, the at least one trailer parameter includes the size of the front end of the trailer. In at least some implementations, the size of the front end of the trailer is determined by interpretation of data from a camera or a reflective sensor. In at least some implementations, the size of the front end of the trailer includes a height and a width of the front end of the trailer.

In at least some implementations, the at least one trailer parameter includes a length between a front end and a rear end of the trailer. In at least some implementations, the vehicle includes a trailer reverse steering assist system that controls at least part of a vehicle steering assembly when the vehicle is operated in reverse, and wherein the length is determined by the trailer reverse steering assist system. In at least some implementations, the trailer reverse steering assist system includes one or more cameras or one or more reflective sensors that are used to detect the presence of the trailer and the length of the trailer. In at least some implementations, the trailer reverse steering assist system also determines a width of the front end of the trailer.

In at least some implementations, the vehicle includes a blind spot monitoring system including one or more sensors that determine the location of opposite sides of the trailer between a front end of the trailer and a rear end of the trailer, and wherein the sensors are used to provide an alert to a driver of the vehicle when an object is detected at one of the opposite sides of the trailer, and wherein the length is determined by the blind spot monitoring system.

In at least some implementations, the method includes determining at least one environmental parameter and determining an adjustment to the vehicle range as a function of the at least one environmental parameter. In at least some implementations, the at least one environmental parameter includes one or both of an ambient temperature and a road friction estimation.

In at least some implementations, the method also includes determining a path of travel and determining an adjustment to the vehicle range as a function of the path of travel. In at least some implementations, the method includes determining information about speed limits of roads in the path of travel and a number of stops along the path of travel.

In at least some implementations, a system for determining range of a vehicle when the vehicle is connected to a trailer has a load sensor adapted to detect a load of a trailer connected to a vehicle and providing a load sensor output, a trailer size sensor adapted to detect at least one parameter related to the size of the trailer and providing a trailer size sensor output and a control system. The control system is communicated with the load sensor and the trailer size sensor, and is responsive to the load sensor output and the trailer size sensor output to estimate a range of the combination of the vehicle and trailer.

In at least some implementations, the load sensor is part of a suspension system of the vehicle and includes one or both of a ride height sensor and a ride height adjustment device. In at least some implementations, the ride height sensor detects a decrease in ride height when the trailer is connected to the vehicle and the control system actuates the ride height adjustment device to increase the ride height, and wherein, to estimate the load of the trailer on the vehicle, the control system is responsive to one or both of the magnitude of a change in the vehicle ride height and the force from the ride height adjustment device needed to increase the ride height.

In at least some implementations, the trailer size sensor includes at least one camera or at least one reflective sensor, and wherein the controller is connected with the at least one camera or the at least one reflective sensor and the control system determines a size of a front end of the trailer. In at least some implementations, the control system determines a length of the trailer based at least in part upon data from the at least one camera or the at least one reflective sensor.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle with a trailer connected to the vehicle;

FIG. 2 is a view of the side of the vehicle and trailer;

FIG. 3 is a diagrammatic view of the front end of the trailer;

FIG. 4 shows an interface by which a user can select information about an intended path of travel; and

FIG. 5 is a flowchart of a method of estimating the range of a vehicle towing a trailer.

### DETAILED DESCRIPTION

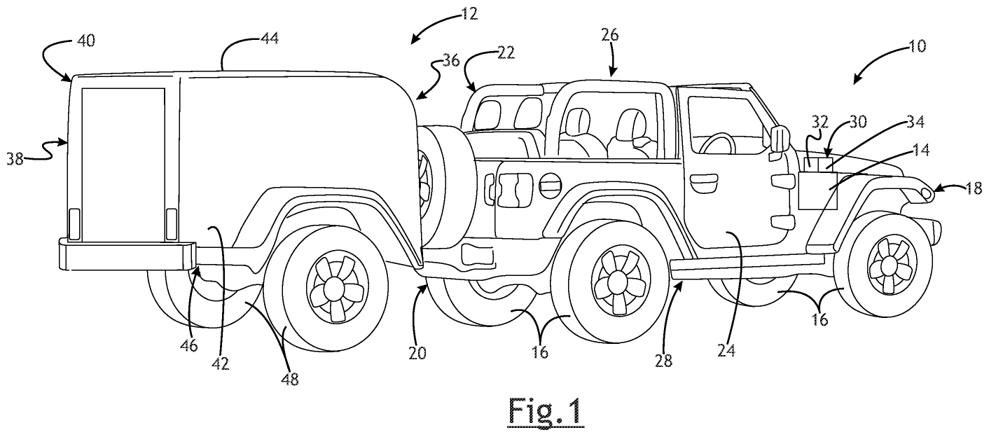

Referring in more detail to the drawings, FIG. 1 illustrates a vehicle 10 that is connected to a trailer 12. The vehicle 10 includes a prime mover 14 such as a combustion engine, an electric motor or both as in a hybrid vehicle 10. The prime mover 14 is coupled to the vehicle wheels 16 to drive the vehicle 10. The vehicle 10 has a front end 18 spaced from a rear end 20 in a fore-aft direction, left and right sides 22, 24 spaced apart in a cross-car direction and top and bottom sides 26, 28 spaced apart in a vertical direction. The vehicle 10 also includes a control system 30 that has one or more processors 32 and memory 34 including instructions for various functions carried out by the control system 30.

One function of the control system 30 is to estimate the range that the vehicle 10 can travel on a current supply of energy. In a combustion vehicle 10, the energy supply includes fuel stored in a fuel tank the level of which is communicated with the control system 30 so that an estimated range of the vehicle 10 can be determined based at least in part on the fuel level. In an electric vehicle 10, the energy supply includes one or more batteries or other supply of electrical power, and the amount of energy available to a motor of the electrical vehicle 10 is communicated with the control system 30 to permit range estimation by the control system 30. And in a hybrid vehicle 10, the energy supply includes both fuel and stored electrical energy, the levels of both of which are communicated with the control system 30 to permit range estimation by the control system 30.

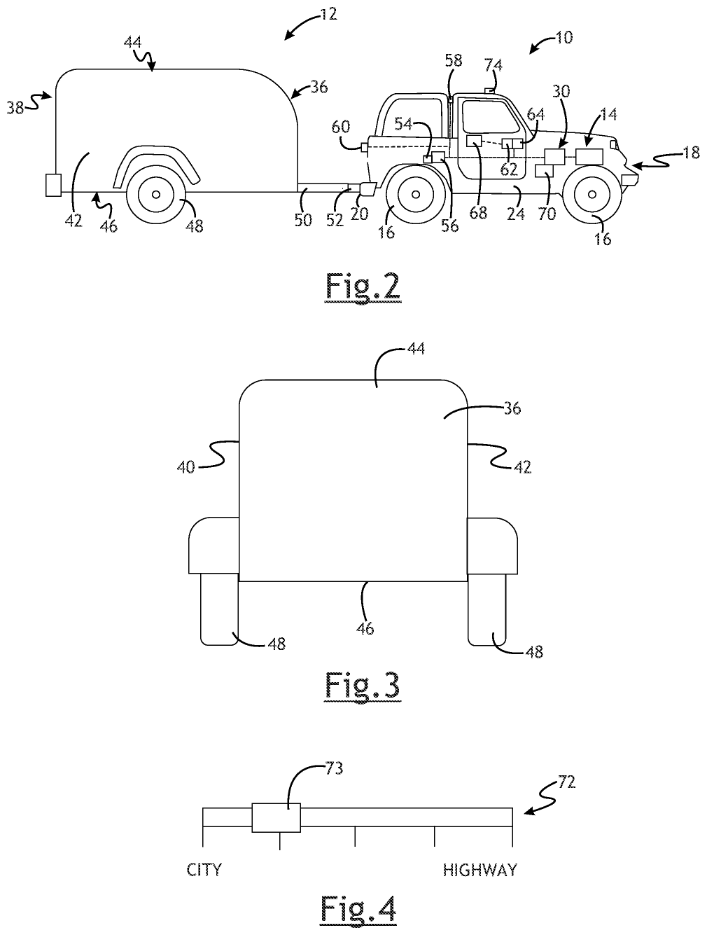

The trailer 12 likewise includes a front end 36 and a rear end 38 spaced apart in the fore-aft direction, left and right sides 40, 42 spaced apart in the cross-car direction and top and bottom sides 44, 46 spaced apart in the vertical direction. Trailer wheels 48 are provided adjacent to the left and right sides 40, 42 of the trailer 12, and between the front and rear ends 36, 38 of the trailer 12. As shown in FIG. 2, a tongue 50 of the trailer 12 extends from the front end 36 of the trailer 12 and is connectable to a hitch 52 of the vehicle 10 that is located at the rear end 20 of the vehicle 10. In this way, the front end 36 of the trailer 12 is adjacent to the rear end 20 of the vehicle 10, and the trailer 12 is pulled behind the vehicle 10 when the vehicle 10 moves forward.

When the trailer 12 is connected to the vehicle 10, it takes more energy to move the combination of the trailer 12 and vehicle 10 than it does for the vehicle 10 alone. The extra energy is needed due, for example, to the extra weight of the trailer 12 and its contents, as well as increased drag caused by the trailer 12. These trailer parameters are non-limiting examples of things that can reduce vehicle range. Other examples include environmental parameters like ambient air temperature and different road surfaces, with examples being paved roads permitting greater range than dirt or sand roads/paths.

To determine the range of travel on a supply of energy for the vehicle 10 and the trailer 12, the vehicle 10 includes one or more sensors arranged to determine parameters that affect vehicle range. For example, and with reference to FIG. 2, the vehicle 10 may include one or more load sensors 54 that are adapted to detect a load of a trailer 12 connected to a vehicle 10 and provide a load sensor 54 output to the control system 30 that is indicative of the trailer 12 load on the vehicle 10. The control system 30, in this example, includes instructions for determining the affect of increased load from a trailer 12 on the vehicle range. The load sensor 54 may be a force or mass sensor associated with the vehicle hitch 52 and having an output that is indicative of the force of the trailer 12 on the hitch 52.

In addition or instead, the load sensor 54 may be associated with a vehicle ride height system 56 that includes a ride height adjustment device, such as a suspension component having a pressurized fluid (hydraulic or pneumatic) the pressure of which can be changed to alter the vehicle 10 ride height. For example, increased load in or on the vehicle 10 can cause the vehicle suspension to permit vehicle 10 travel toward the ground, reducing ride height (e.g. clearance between the vehicle and the ground). The pressure of the suspension component fluid may be increased to raise the vehicle body relative to the ground, and the pressure required to achieve a desired ride height is a function of the load on the vehicle 10 and can be used by the control system 30 to estimate the vehicle load, where the addition of the trailer 12 increases the load on the vehicle 10. Of course, ride height adjustment systems 56 may use actuators other than pressurized fluid components, such as those driven by electric motors or other electromechanical systems. In at least some implementations, a movement or other change in the suspension system can be correlated to a load of the trailer 12. This may be done as a function of one or both of the magnitude of a change in the vehicle ride height and/or a force from the ride height adjustment device needed to increase the ride height.

By way of another example, the vehicle 10 may include one or more sensors adapted to detect at least one parameter related to the size of the trailer 12 and provide an output indicative of the size parameter. In one example, the area of the front end 36 of the trailer 12 (e.g. cross-car width between sides 40, 42 times vertical height between the top 44 and bottom 46, diagrammatically shown in FIG. 3) is determined or estimated because this area is very relevant to the amount of increased air resistance or drag caused by the trailer 12, where increased drag requires increased energy to move the vehicle 10 and trailer 12.

In one example, the area of the front end 36 of the trailer 12 is determined by one or more cameras 58 on the vehicle 10 and having a field of view that includes an area behind the rear end 38 of the vehicle 10. Such cameras 58 are common in modern vehicles to provide a video feed to a display screen in the vehicle 10 when the vehicle 10 is in reverse gear or reverse drive mode to improve driver visibility of the area behind the vehicle 10. The cameras 58 could also or instead be used for digital rear-view mirrors, lane identification or lane keeping assist systems, Advanced Driver Assist Systems (ADAS, e.g. autonomous or semi-autonomous driving systems), or to detect objects behind the vehicle 10 even when the vehicle 10 is not in reverse. Further, with object recognition techniques, the type or model of trailer may be determinable from one or more images from one or more cameras 58. The system could then determine the trailer dimensions and other information, as desired, from online sources.

In addition to or instead of one or more cameras 58, the vehicle 10 may include at least one reflective sensor 60 that emits waves (e.g. light or sound or electromagnetic or ultrasonic) and that receives reflected waves to determine the presence of objects in the path of the emissions, and may also determine the distance to the objects and the object size and shape (e.g. size and shape of surfaces that reflect waves back toward the sensor). For example, sonar or radar or LIDAR sensors may be used to provide information for ADAS and other vehicle 10 systems, like blind spot monitoring systems. The output(s) from such sensors 60 may be communicated with the control system 30 which may include instructions to determine from the output(s) a size of at least the front end 36 of the trailer 12. The front end 36 of the trailer 12 can be a significant source of drag and thus, estimating the range as a function of the area of at least part of the front end 36 of the trailer 12 can, in at least some implementations, provide a suitable estimation of the energy needed to tow the trailer 12 and thus, a reduction in the range of the vehicle 10 towing the trailer 12.

The cameras 58 and/or sensors 60 may be used by existing vehicle 10 systems such as a trailer reverse steering control system 62 that controls at least part of a vehicle steering assembly 64 when the vehicle 10 is operated in reverse. Such systems 62 facilitate reverse operation of the vehicle 10 and trailer 12 which can be tricky to do accurately in view of the pivoted connection of the trailer 12 and vehicle 10. These systems may determine a length of the trailer 12 between the front end 36 and the rear end 38 (and the width between the left and right sides 40, 42) to improve and facilitate control of the vehicle 10 and trailer 12. Similarly, the cameras 58 and/or sensors 60 may be used in a blind spot monitoring system 68 that may determine the location of opposite sides 40, 42 of the trailer 12 and the length of the trailer 12. The blind spot monitoring system 68 may then detect objects next to or approaching the sides of the trailer 12 and provide an alert to a driver of the vehicle 10 when an object is detected adjacent to one of the opposite sides 40, 42 of the trailer 12.

While one or the other of a load sensor 54 and a size sensor 58, 60 may be used, in at least some implementations a system for determining range of a vehicle 10 when the vehicle 10 is connected to a trailer 12 includes both a load sensor 54 and a trailer size sensor 58, 60. The load sensor 54 and trailer size sensor 58, 60 provide outputs to the control system 30 which is responsive to the load sensor output and the trailer size sensor output to estimate the range of the combination of the vehicle 10 and trailer 12. The range estimation/determination can be made as a function of a reduction in range attributable to the trailer 12 and reduced from a range determination made based on the vehicle 10 by itself, or as a function of the combined range of the vehicle 10 and trailer 12.

In at least some implementations, information about the vehicle's intended path of travel can be used to determine the vehicle range with or without the trailer 12. For example, path of travel information may be determined by a navigation system 70 which may be or include a navigation program executed by the vehicle or on a mobile device connected to the vehicle and communicated with the control system 30. The path of travel information may include information about the different types of roads within the path of travel, which may be differentiated by speed limits, whether stop lights, turns or other features are required (e.g. highway or rural or city roads or some combination). Traffic information is commonly available from navigation systems and so the average speed, number of stops and average speed data can be used to determine range. This may be useful to provide a better range estimate when pulling a trailer 12 because it may take more energy to initially move the vehicle 10 and trailer 12 and so multiple stops along a path of travel can consume more energy and reduce the vehicle range. While path of travel information may be provided from a navigation system 70, a user could also enter information about the path of travel and/or type of roads to be traveled (e.g. highway or city), via a program interface 72 provided on a vehicle infotainment system or on a mobile device that is connected to or communicated with the control system 30, to enable a more accurate determination of the vehicle range. A representative interface 72 is shown in FIG. 4 and includes a slider 73 that may be moved by a user to indicate relative amounts of city driving and highway driving along an intended path of travel.

Still further, in at least some implementations, information regarding one or more environmental parameters may be used to determine the range of the vehicle 10 and the trailer 12. For example, the system may determine one or both of an ambient temperature (via a temperature sensor 74) and a road friction estimation which may be determined by the control system 30. Colder ambient air temperatures mean that the air is denser and so increased drag from the trailer 12 may have a larger effect on the vehicle range. Roads with less friction, such as dirt, gravel, sand or snowy roads, can require greater energy to move the vehicle 10 and the extra weight of the trailer 12 and tendency for the trailer 12 to slip or slide on low friction surfaces may increase the energy used to move the vehicle 10.

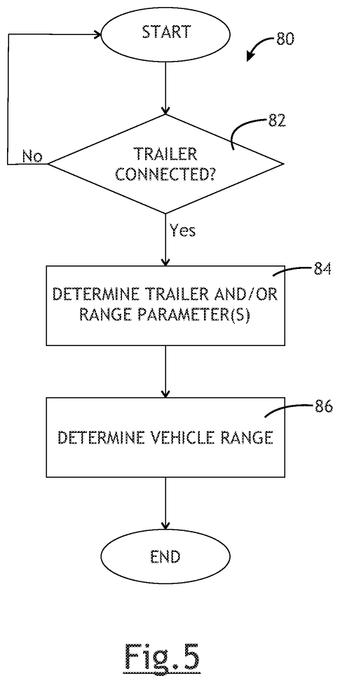

FIG. 5 is a flowchart of a method 80 for determining range for a vehicle 10 connected to a trailer 12. In step 82, connection of a trailer 12 to the vehicle 10 is determined or detected. This may be done automatically by interpretation of output from the camera(s) 58 or other sensor(s) 60 by which presence of a trailer 12 behind the vehicle 10 can be determined, as noted above. This may also or instead by done in response to output from the load sensor(s) 54, such as a change in ride height of a stationary vehicle 10 indicating a load applied to the vehicle 10. This may also or instead be done by determination that an electrical connector of the trailer 12 is connected to an electrical connector of the vehicle 10, such as to power taillights on the trailer 12. Such electrical connections are commonly made in the area of the vehicle 10 hitch 52. Further, this may be done by a user inputting the trailer connection into a program interface via the vehicle 10 infotainment system or an application on a mobile device.

After connection of a trailer 12 to the vehicle 10 is determined, the method continues to step 84 in which at least one trailer 12 parameter relating to a size, shape or a weight of the trailer 12 is determined, as set forth above. Thereafter, in step 86, the vehicle range is determined as a function of the at least one trailer 12 parameter, and/or other parameters affecting range as noted herein. As described above, the method may also include determining at least one environmental parameter and determining an adjustment to the vehicle range as a function of the at least one environmental parameter. In at least some implementations, the at least one environmental parameter includes one or both of an ambient temperature and a road friction estimation. Further, the method may include determining information relating to a path of travel and determining an adjustment to the vehicle range as a function of the information. In at least some implementations, the information relates to speed limit(s), such as an average speed limit of roads in the path of travel and a number of stops along the path of travel. The vehicle range calculation may be performed periodically, as desired, to update the range estimated based on the energy level remaining in the vehicle (e.g. fuel level or battery charge level).

The systems and methods set forth herein enable automatic determination of a vehicle range when the vehicle 10 is pulling a trailer 12. While this may be useful with vehicles having combustion engines, the systems and methods may be of particular interest to drivers of electric vehicles due to the current relative scarcity of charging stations in at least certain areas (relative to the current availability of refueling stations). More accurate vehicle range estimations can facilitate planning a path of travel which may include the need to stop and recharge the vehicle's electrical power supply.

What is claimed is:

1. A method for determining range for a vehicle connected to a trailer, comprising:
determining connection of a trailer to the vehicle;
determining at least one trailer parameter relating to a size, shape or a weight of the trailer; and
determining a reduction in vehicle range as a function of the at least one trailer parameter.

2. The method of claim 1 wherein the at least one trailer parameter includes an estimated weight of the trailer, and the estimated weight of the trailer is determined by a load sensor of the vehicle.

3. The method of claim 2 wherein the load sensor is a ride height sensor of a vehicle suspension system.

4. The method of claim 1 wherein the at least one trailer parameter includes the size of the front end of the trailer.

5. The method of claim 4 wherein the size of the front end of the trailer is determined by interpretation of data from a camera or a reflective sensor.

6. The method of claim 4 wherein the size of the front end of the trailer includes a height and a width of the front end of the trailer.

7. The method of claim 1 wherein the at least one trailer parameter includes a length between a front end and a rear end of the trailer.

8. The method of claim 7 wherein the vehicle includes a trailer reverse steering control system that controls at least part of a vehicle steering assembly when the vehicle is operated in reverse, and wherein the length is determined by the trailer reverse steering assist system.

9. The method of claim 8 wherein the trailer reverse steering assist system includes one or more cameras or one or more reflective sensors that are used to detect the presence of the trailer and the length of the trailer.

10. The method of claim 8 wherein the trailer reverse steering assist system also determines a width of the front end of the trailer.

11. The method of claim 7 wherein the vehicle includes a blind spot monitoring system including one or more cameras that determine the location of opposite sides of the trailer between a front end of the trailer and a rear end of the trailer, and wherein the cameras are used to provide an alert to a driver of the vehicle when an object is detected at one of the opposite sides of the trailer, and wherein the length is determined by the blind spot monitoring system.

12. The method of claim 1 which also includes determining at least one environmental parameter and determining an adjustment to the vehicle range as a function of the at least one environmental parameter.

13. The method of claim 12 wherein the at least one environmental parameter includes one or both of an ambient temperature and a road friction estimation.

14. The method of claim 1 which also includes determining a path of travel and determining an adjustment to the vehicle range as a function of the path of travel.

15. The method of claim 14 which includes determining information about speed limits of roads in the path of travel and a number of stops along the path of travel.

16. A system for determining range of a vehicle when the vehicle is connected to a trailer, comprising:
a load sensor adapted to detect a load of a trailer connected to a vehicle and providing a load sensor output;
a trailer size sensor adapted to detect at least one parameter related to the size of the trailer and providing a trailer size sensor output;
a controller communicated with the load sensor and the trailer size sensor, and responsive to the load sensor output and the trailer size sensor output to estimate a range of the combination of the vehicle and trailer.

17. The system of claim 16 wherein the load sensor is part of a suspension system of the vehicle and includes one or both of a ride height sensor and a ride height adjustment device.

18. The system of claim 17 wherein the ride height sensor detects a decrease in ride height when the trailer is connected to the vehicle and the control system actuates the ride height adjustment device to increase the ride height, and wherein, to estimate the load of the trailer on the vehicle, the controller is responsive to one or both of the magnitude of a change in the vehicle ride height and the force from the ride height adjustment device needed to increase the ride height.

19. The system of claim 16 wherein the trailer size sensor includes at least one camera or at least one reflective sensor, and wherein the controller is connected with the at least one camera or the at least one reflective sensor and the controller determines a size of a front end of the trailer.

20. The system of claim 19 wherein the controller determines a length of the trailer based at least in part upon data from the at least one camera or the at least one reflective sensor.
